(19) United States
(12) Patent Application Publication
(10) Pub. No.: US 2008/0135266 A1
(43) Pub. Date: Jun. 12, 2008

(54) Sodium azide based suppression of fires

(76) Inventors: Adam T. Richardson, Belleville (CA); Joseph Michael Bennett, Hendersonville, TN (US)

Correspondence Address: Matthew D. Powell;Sim & McBurney, 6th Floor, 330 University Avenue, Toronto, ON, M5G 1R7, omitted

(21) Appl. No.: 11/878,999

(22) Filed: Jul. 30, 2007

Related U.S. Application Data
(60) Provisional application No. 60/873,979, filed on Dec. 11, 2006.

(51) Int. Cl. A62C 35/02

(52) U.S. Cl. 169/46; 169/71; 169/78; 169/89

(57) ABSTRACT

A device and method device for delivering a fire suppressing gas to a space is provided. The device includes a housing disposed within the space; at least one generator disposed within the housing and containing pre-packed sodium azide based propellant; an ignition device for igniting said sodium azide based propellant and thereby generating a low-moisture fire suppressing gas; and an opening in the housing for directing the fire suppressing gas mixture into said space.

### CROSS REFERENCE TO RELATED APPLICATION

This application claims priority under 35 U.S.C. 119(e) from U.S. Provisional Patent Application No. 60/873,979 filed Dec. 11, 2006.

### FIELD OF THE INVENTION

The present invention is directed to a system and method for suppressing fires in normally occupied areas.

### BACKGROUND OF THE INVENTION

Numerous systems and methods for extinguishing fires in a building have been developed. Historically, the most common method of fire suppression has been the use of sprinkler systems to spray water into a building for cooling the fire and wetting additional fuel that the fire requires to propagate. One problem with this approach is the damage that is caused by the water to the contents of the occupied space.

The “total flood” clean agent fire protection system industry provides high value asset protection for spaces, such as computer rooms, telecommunications facilities, museums, record storage areas, and those housing power generation equipment. “Total flood” protection in such applications is provided by automatically filling the protected compartment completely at a uniform concentration that assures that the fire will be extinguished, no matter where it might be located. The extinguishing medium used in such systems is expected to be “clean”—that is, leave no or very little residue behind after discharge that must be cleaned up.

Known total flood fire protection systems typically comprise a bank of several (commonly tens or more) thick-walled metal bottles for holding an extinguishant (either liquefied or in the gaseous state) at high pressure to permit high-density storage. The extinguishant is released via either manual or automatic activation of high-strength, special purpose valves on the bottles. In order to transmit an extinguishant at masses required to meet precise extinguishing concentrations within a tight tolerance band of room concentration required to meet both the extinguishing and inhalation toxicity requirements, a complex plumbing network designed for the space is required. Furthermore, independent capacities required for individual rooms in a typical multi-room protection scenario (such as a factory or high-rise building) using the same distribution network must be accounted for. Such design and corresponding installation work, including development of flow calculation methodologies for complex flow considerations, requires considerable up-front effort and expense.

High-pressure bottles require frequent inspection due to their propensity for leaks. Once a leak is identified, the leaking bottle may need to be sent to a central re-filling installation, resulting in protection down time at the customer site. Such down time can also be experienced in the event of a man-made or natural disaster, such as a gas leak explosion, tornado or earthquake, which can also damage the piping network itself.

The fluorocarbon known as Halon 1301 has been used in “total flood” systems because it is clean, somewhat non-toxic and highly efficient. Due to their use of ozone depleting greenhouse gases, however, systems employing Halon 1301 are being replaced by more environmentally friendly alternative systems, as mandated by the 1987 Montreal and 1997 Kyoto International Protocols. One example of a Halon 1301 alternative system uses the hydroflourocarbon HFC-227ea (e.g. Marketed as “FM-200” or “FE-227” in Fire Suppression Systems such as those manufactured by Kidde Fire Systems).

Such “first generation” Halon alternatives, including “clean” hydrofluorocarbons behave in a similar manner to Halon 1301, but have been found not to be as effective in comparison since they typically do not have the flame chemistry inhibition of Halon 1301. As a result, fire suppression systems using Halon replacements require from two to ten times the extinguishant mass and storage space, and are therefore more costly. Furthermore, the increased storage space required for the large increase in number of extinguishant bottles poses a difficult placement problem for facility engineers, and a considerable obstacle for those wishing to retrofit an existing Halon installation with a bottle “farm” many times bigger than its Halon predecessor in a limited storage space.

Most of these Halon alternative hydrofluorocarbons have human exposure toxicity limits very close to their required extinguishing design concentrations. They are therefore more sensitive to changes in room storage filling capacity in terms of occupant risk. Such exposure times are typically limited to five minute or less providing occupants with reduced evacuation capability. Occupants who are injured, aged, disabled and may also be medical patients may find this evacuation time challenging, and the increased cardio toxicity risk with many of these Halon alternative extinguishants makes limited exposure scenarios even more critical.

Once discharged into a room, known Halon alternatives of this type are hydrofluorocarbons having a propensity to decompose into large quantities of hydrogen fluoride, after exposure to an open flame. Hydrogen fluoride can produce a caustic acid when exposed to moisture that can pose a significant health hazard to occupants and rescue personnel, and can damage equipment. For this reason, at least the U.S. Navy uses water mist to wash out hydrofluoric acid after hydrofluorocarbon (“HFC”) discharge in a machinery space fire, in addition to cooling the compartments, to protect firefighter personnel. Furthermore, HFC chemicals have been determined to have long atmospheric lifetimes, thereby making them subject to subsequent global warming legislation worldwide in line with the Kyoto Protocol over the next few years. Also, the California Environmental Protection Agency's, Assembly Bill 32, the global warming solutions act of 2006, bans the eventual use of HFC's in fire systems.

“Environmentally friendly” alternatives to the hydrofluorocarbons have been proposed and even fielded to a limited degree, but many also suffer from their own design and operational limitations. Water mist systems were devised to use less water than sprinkler systems, and hence cause less water-related damage, although such damage is only reduced, not eliminated. Even with considerable research and engineering expertise applied internationally, it has proven very difficult to design mist delivery systems for fire suppression around obstacles that are as effective as gases. The efficiency of suppression is largely influenced by the size and nature of the fire. Inert gas systems, such as those using nitrogen or argon, require up to ten times the number of bottles of their Halon predecessor (due to their inefficiency and inability to be liquefied under pressure in a practical manner). Such requires not only considerable additional storage space, but often larger diameter plumbing that would need to replace Halon-suitable pipes. The very high pressure bottles used in inert gas systems can also pose an additional safety hazard if damaged or otherwise compromised, including the thicker-walled distribution plumbing that might be vulnerable at any joint connections.

Another method for fire suppression involves dispersal of gases such as nitrogen, in order to displace oxygen in an enclosed space and thereby terminate a fire while still rendering the enclosed space safe for human occupancy for a period of time. For example, U.S. Pat. No. 4,601,344, issued to The Secretary of the Navy, discloses a method of using a glycidyl azide polymer composition and a high nitrogen solid additive to generate nitrogen gas for use in suppressing fires. This patent envisions delivery of a generated gas to a fire via pipes and ducts, and does not disclose any particular means by which to package the solid additive. Furthermore, the patent does not consider the challenges in distributing an appropriate quantity of generated nitrogen gas into a habitable space and does not to consider concentrations that would reliably extinguish fires, while permitting the safe occupancy and exposure to humans for a time.

According to the requirements for inert gas generator fire suppression systems inside a normally occupied space set by the National Fire Protection Association (NFPA) such as NFPA Standard 2001, the US United States Environment Protection Agency (EPA) such as the SNAP List, and UL/FM/ULC Listings & Approvals, a space must be able to be occupied for up to five (5) minutes. Furthermore, inert gases must be reduced to a maximum of 75 degrees Celsius or 167 degrees Fahrenheit at the generator's discharge port.

U.S. Pat. Nos. 6,016,874 and 6,257,341 (Bennett) disclose the use of a dischargeable container having self-contained therein an inert gas composition. A discharge valve controls the flow of the gas composition from the closed container into a conduit. A solid propellant is ignited by an electric squib and burns thereby generating nitrogen gas. This patent envisions delivery of a generated gas via a conduit into a space.

U.S. Pat. No. 7,028,782 (Richardson) and U.S. Patent Application Publication No. 2005/0189123 (Richardson et al.) disclose means of exploiting gas generator technology by use of non-azide propellants in a stand-alone system featuring multiple individual gas generator cartridges in a given container. Some non-azide materials produce water vapor, however, which can condense onto the walls and other surfaces of the compartment to be protected. Some end users prefer protection schemes that pose little or no possibility of any such water condensation that might harm paper records or other moisture-sensitive contents. Furthermore, the extinguishant from non-azide materials is typically extremely hot, and therefore must be cooled significantly for use in normally occupied spaces. Cooling is achieved with the use of a large mass of cooling bed material also stored in proximity to the multi-cartridge container. The large mass takes up space that could be filled with additional generators, thereby reducing the overall protection space efficiency of a given cartridge container.

Although systems exist for total flood fire suppression applications, improvements are of course desirable. It is an object of the present invention to provide a device and method for delivering a fire suppressing gas into a space.

### SUMMARY OF THE INVENTION

According to an aspect, there is provided a device for delivering a fire suppressing gas to a space, comprising:

a housing disposed within the space;

at least one generator disposed within the housing and containing pre-packed sodium azide propellant;

an ignition device for igniting said sodium azide propellant and thereby generating a low-moisture fire suppressing gas; and

an opening in the housing for directing the fire suppressing gas mixture into said space.

According to another aspect, there is provided an apparatus for suppressing fires in a space comprising:

a sensor for detecting a fire;

at least one solid sodium azide based inert gas generator for generating and delivering a fire suppressing, substantially dry nitrogen gas mixture to the space upon receiving a signal from the sensor; and

an inert gas discharge diffuser to direct the fire suppressing gas mixture into said space.

According to another aspect, there is provided a method of suppressing fires in a space comprising:

generating a first fire suppressing gas mixture from at least one sodium azide based propellant chemical, the first fire suppressing gas mixture comprising primarily nitrogen,

filtering at least one of moisture, additional gases and solid particulates from the first fire suppressing gas mixture to produce a second fire suppressing gas mixture; and

delivering the second fire suppressing gas mixture into the space.

According to another aspect, there is provided an apparatus for suppressing fires in a normally occupied and or un-occupied space comprising:

a sensor for detecting a fire;

at least one solid sodium azide based inert gas generator for generating and delivering a fire suppressing, substantially dry gas mixture including nitrogen to the space upon receiving a signal from the sensor; and

an inert gas discharge diffuser to direct the fire suppressing gas mixture into said space.

According to another aspect, there is provided a gas generator for generating and delivering a substantially dry fire suppressing gas mixture to a space, comprising:

a housing;

at least one pre-packed sodium azide propellant disposed within said housing;

a pyrotechnic device for igniting said sodium azide propellant and thereby generating said fire suppressing gas mixture; and

a discharge diffuser for directing the fire suppressing gas mixture within said enclosed space.

Previously, sodium azide based propellants were generally thought to be unsuitable for normally occupied spaces. Further research has revealed that sodium azide based propellants can now be provided which are indeed suitable for normally occupied spaces.

A sodium azide based propellant is preferable in many applications due to its ready availability and affordability, and its characteristic of producing nearly-pure nitrogen gas as its gaseous post-combustion by-product. The sodium azide may be mixed with other minor ingredients which serve as propellant binders or provide other operational performance enhancements, as is commonly known to those skilled in the art.

Advantageously, propellants generated by sodium azide based materials are typically 10% to 15% of the temperature those generated by non-azide based propellants. For example, it is typical for sodium azide propellants to burn at approximately 400 degrees Fahrenheit and non-azide propellants to burn at approximately 3,000 degrees Fahrenheit. Thus, sodium azide based propellants require approximately only 10% to 15% of the bulk heat sink required for such non-azide based propellants. Use of sodium azide based materials therefore permits a significant reduction in size, or the inclusion of more propellant generators in a given volume.

In one embodiment, multiple, uniformly-sized solid propellant gas generator cartridges are incorporated into a single “tower” design installed in the space to be protected without piping or ducts. This design eliminates the need for remote bottle installation and a network of distribution plumbing that would otherwise be required.

Each tower may be configured to protect a given number of cubic feet of free compartment volume. For example, multiple towers with several cartridges may be used for large areas, while fractional volume coverage can be achieved by simply reducing the number of cartridges in a given tower.

These normally non-pressurized towers, when activated either manually or by use of a conventional fire alarm panel, in turn activate propellant generation by multiple generator cartridges in a tower, sequencing each of them in order after each cartridge has completed its individual discharge.

Even though the cartridges have a shelf life of many years (possibly up to twenty), their replacement is made simple by simple removal and re-insertions of “fresh” cartridges, which can be performed by personnel on site without the need to ship units for refurbishment, nor requiring personnel with special training and tools for high-pressure equipment. This dramatically reduces cost of ownership.

The simplicity of the installation and maintenance approach provides opportunities for distributors that do not currently have deployed teams of pressurized equipment-experienced field personnel to offer products to their customers using their current personnel support infrastructure.

The solid gas propellant is housed within a tower system positioned within a space to be protected, and therefore requires no piping. This represents a dramatic reduction in cost and also results in minimal asset protection “down time” during replacement of existing Halon 1301 systems.

The towers of the present invention do not have to be removed from the location they are protecting in order to be recharged. Rather, the inventive system may be recharged on site through the use of pre-packed sodium azide-based propellant generators. The system is preferably operated to permit human life to be maintained for a period of time (e.g. by maintaining a sufficient mix of gases in the building to permit human habitation for a period of time while still being useful for suppressing fires).

According to an alternative embodiment, the gas generator units are suspended from the ceiling, or actually mounted on the ceiling or suspended above a drop ceiling and or in a raised floor space commonly used as electrical supply “race ways” inside computer, server net, programmable controller rooms, etc., utilized around the world. Such mounting locations can be selected to not impede personnel operations or occupation of usable space within the room. Protection units may be a single unit sized for the compartment volume to be protected or an assemblage of smaller individual cartridges mounted within a fixture, with sufficient cartridges added to protect a given protected volume. These singular and or multiple gas generators mounted in unoccupied spaces can have an external heat sink module added to each generator if required.

In one embodiment, a bracket is mounted in a sub-floor of, for example, a computer room and supports multiple generators.

The suppressing gas mixture permits the space to be habitable by human life for a predetermined time. Preferably, the predetermined time ranges from about one to five minutes, as per the requirements of the National Fire Protection Association's 2001 standard for clean agent Halon 1301 alternatives and the US EPA SNAP Listings for fire suppression use in occupied spaces.

In one embodiment, the apparatus further comprises at least one filter and screen for filtering any solid particulates and reducing the heat of the gas generated prior to the delivery of the fire suppressing gas to the normally occupied and or unoccupied space.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Embodiments will now be described more fully with reference to the accompanying drawings, in which:

FIG. 1A shows an assembled gas generator fire suppression tower according to the preferred embodiment;

FIG. 1B is an exploded view of the fire suppression tower of FIG. 1A;

FIG. 2A shows electrical connections to a diffuser cap of the tower in FIGS. 1A and 1B;

FIGS. 2B-2D show alternative embodiments of diffuser caps for use with the gas generator fire suppression tower of FIGS. 1A and 1B;

FIG. 3 is a schematic view of an enclosed space protected using the gas generator fire suppression towers of the present invention;

FIG. 4 is an illustration and partial cross section of a single gas generator unit mounted in a corner of a room to be protected, according to an alternative embodiment of the invention;

FIG. 5 is an illustration of a variation of the single gas generator room unit of FIG. 4, comprised of multiple gas generator cartridges;

FIG. 6 is an illustration of a ceiling mounted fixture, holding multiple gas generator cartridges, according to a further alternative embodiment of the invention;

FIG. 7 is an illustration of a ceiling mounted fixture, comprised of multiple recessed gas generator units, according to yet another alternative embodiment of the invention;

FIG. 8 is an alternative embodiment of a tower;

FIG. 9 is another alternative embodiment of a tower, with a bracket for securing multiple propellant cartridges there within;

FIG. 10 shows installation of the power harness on a cartridge prior to its connection to the bracket of FIG. 9;

FIG. 11 shows an alternative bracket for securing single or multiple cartridges in a space without a tower; and

FIG. 12 shows a tower design housing four azide-based nitrogen generating generators.

### DETAILED DESCRIPTION OF THE EMBODIMENTS

A pre-packed solid gas generator for generating a gas mixture from a sodium azide-based chemical that is suitable for suppressing a fire is provided.

According to the preferred embodiment, a solid chemical mixture is provided that is predominantly sodium azide (about 80.3 percent by weight) and sulphur (19.7 percent by weight), as is disclosed in U.S. Pat. No. 3,741,585. Such mixture can generate approximately 60 pounds of nitrogen gas per cubic foot of solid propellant blend. It will be understood that other azide-based blends exist in the current art that satisfy this requirement.

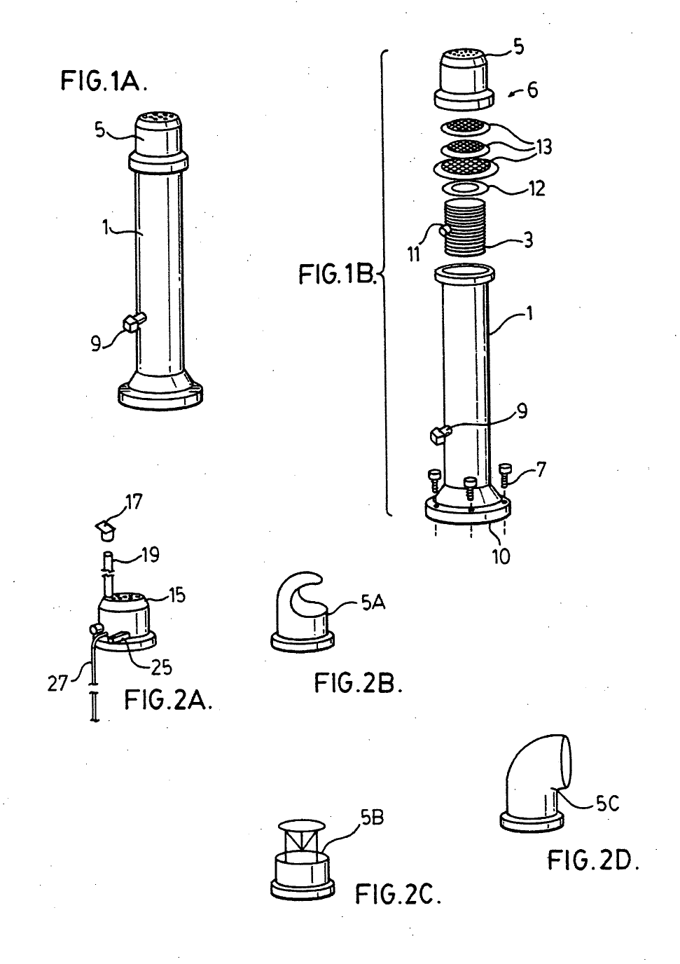

As shown in FIGS. 1A and 1B, a gas generator fire suppression tower 1 is provided containing a pre-packed sodium azide-based solid propellant canister 3 and a discharge diffuser 5 for discharging generated gases. The tower 1 is secured in position by floor mounting bolts 7 passing through a mounting flange 10, or any other suitable means. The diffuser 5 is likewise secured to the tower 1 using flange bolts with nuts 6.

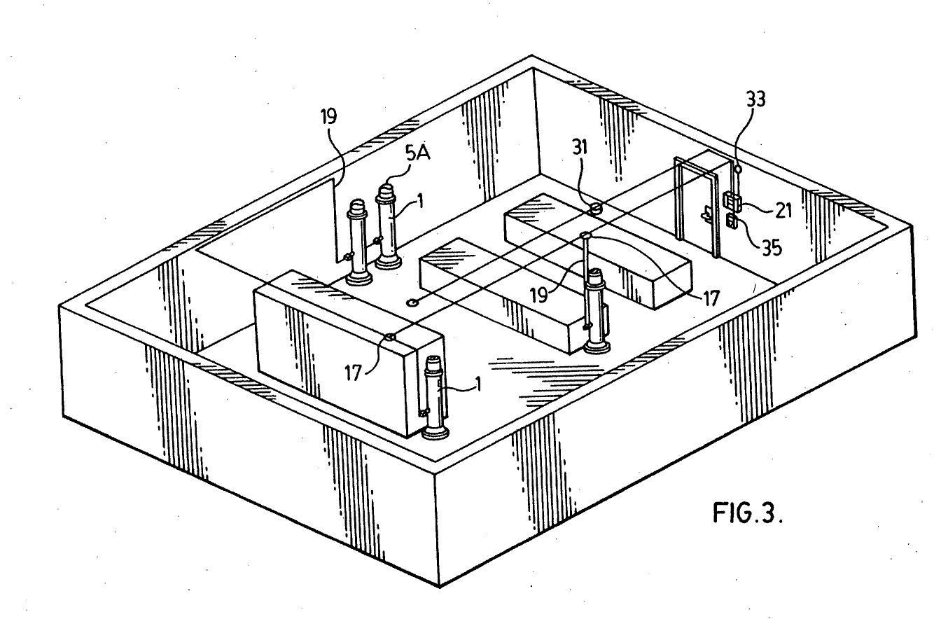

A pyrotechnic device 9 (i.e. a squib) is attached to the pre-packed sodium azide propellant canister 3 by way of a connector 11, and to a fire detection and release control panel discussed in greater detail with reference to FIGS. 2A and 3. The squib is used to initiate the inert gas generation in response to electrical activation.

A propellant retainer 12 may be provided along with various optional filters and/or heat sink screens 13, as discussed in greater detail below.

Turning to FIG. 2A in combination with FIG. 3, the discharge diffuser 5 is shown having a perforated cap 15. A raceway ceiling mounting foot 17 is provided for securing a conduit/wiring raceway 19 (e.g. steel pipe) between the fire detection and release panel 21 (FIG. 3) and a conduit connection 23 on a bracket 25. The conduit continues downwardly to the squib 9, as shown at 27.

FIGS. 2B-2D show alternative embodiments of discharge diffusers 5, for different installations of the tower 1, which may serve either as replacements for the perforated cap diffuser or be placed there over. More particularly, FIG. 2B depicts a 180° directional diffuser cap 5A useful for installations wherein the tower is disposed along a wall. FIG. 2C depicts a 360° directional diffuser cap 5B useful for installations wherein the tower is centrally disposed. FIG. 2D depicts a 90° directional diffuser cap 5C useful for installations wherein the tower is disposed in a corner.

With reference to FIG. 3, a system is shown according to the present invention for suppressing fires in a space using a plurality of towers 1 as set forth in FIGS. 1 and 2. In operation, a sensor 31, upon detecting a fire, issues a signal to the control panel 21 which, in response, activates an alarm signaling device 33 (e.g. audible and/or visual alarm). Alternatively, an alarm may be initiated by activating a manual pull station 35. In response, the control panel 21 initiates a solid gas generator by igniting the pyrotechnic device 9, which in turn ignites the sodium azide chemicals in the pre-packed canister 3 that produce the fire suppressing gas. The fire suppressing gas mixture comprises primarily nitrogen.

The fire suppressing gas mixture may contain trace amounts of carbon dioxide and water vapor, which are optionally filtered using filters 13 (FIG. 1), resulting in the production of a filtered, dry fire suppressing gas mixture, thereby not resulting in any water condensation inside the protected area. More particularly, the fire suppressing gas mixture may be filtered so that the gas introduced into the room (FIG. 3) contains from about zero to about five wt % carbon dioxide and preferably, from about zero to about three wt % carbon dioxide. More preferably, substantially all of the carbon dioxide in the mixture is filtered out of the mixture.

Heat sink screens may be used to reduce the temperature of the fire suppressing gas generated as a result of igniting the pre-packed sodium azide based propellant canister 3. Although the filters and screen(s) 13 are shown as being separate from the pre-packed canister 3, it is contemplated that at least the screen(s) may be incorporated as part of the canister structure. This is possible particularly due to the use of sodium azide based propellant generate, since as stated above the amount of heat sinking required is typically far less than that required of non-azide based generates.

Since there is no requirement to use compressed gas cylinders, discharge piping and discharge nozzles for the supply or transport of an extinguishing gas mixture, the system of FIG. 3 enjoys several advantages over the known prior art. Firstly, the use of solid gas generators allows large amounts of gases to be generated with relatively low storage requirements. This reduces the cost of the system, making it more attractive to retrofit existing Halon 1301 systems with environmentally acceptable alternatives (i.e. inert or near-inert gasses are characterized as being zero ozone depleting and have zero or near-zero global warming potential).

Secondly, the system benefits from simplified installation and control since all of the solid gas generators need not be provided at one central location. Instead, one or more solid gas generators or towers 1 are preferably positioned at the location where the fire will have to be suppressed. In this way, the generation of fire suppressing gases within the hazard area, substantially simplifies the delivery of the gases without the need of a piping system extending throughout a building or perhaps through one or two walls.

Thirdly, the provision of independently positioned towers 1 results in the gas being generated and delivered to the hazard area almost instantaneously as it is released. This increases the response time of the fire suppressing system and its ability to inert the hazard area and suppress the fire in a normally occupied and or unoccupied space. Each solid gas generator 1 is preferably designed to generate a quantity of gas needed to extinguish a fire within a specific volume divided by the actual total volume of space being protected by any one sodium azide based pre-packed propellant generator fire suppression system, should the need arise.

The potentially filtered fire suppressing gas mixture is delivered into the room (FIG. 3) containing a fire. The volume of filtered fire suppressing gas to be delivered into the room depends on the size of the room. Preferably, enough of the filtered fire suppressing gas mixture is delivered into the room to suppress any fire in the room, yet still permit the room to be habitable by human life for a predetermined time. More preferably, a volume of filtered fire suppressing gas mixture is delivered into the room that permits the room to be habitable by human life for approximately one to five minutes, and more preferably from three to five minutes, as per the requirements of the National Fire Protection Association's 2001 Standard for Halon 1301 clean agent alternatives and the US EPA SNAP Listing for fire suppression system's use in normally occupied and or un-occupied spaces.

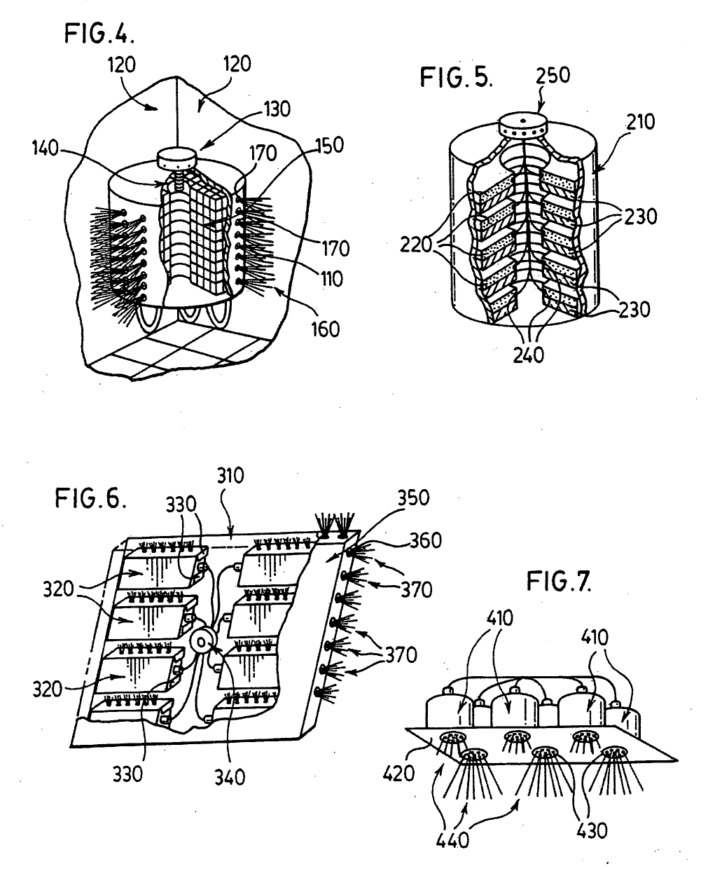

Referring now to the alternative embodiment of FIG. 4, an illustration and partial cross section is provided of a single gas generator unit mounted in a corner of a room to be protected. In this embodiment, the fire protection unit 110 is a floor mounted unit, in a room 120 to be protected from fire. The unit 110 is located in a space in the room that does not inhibit normal use of the room by occupants, or desired positioning of other equipment. An integral smoke or heat detector 130 is mounted on the unit 110 in this embodiment, although it can also be wired to normal ceiling-mounted smoke detectors. Upon detection of a fire or smoke by the detector 130, it sends an electrical signal to the propellant squib 140 that initiates the burning of the gas generator propellant 150, which generates the inert gas 160 in sufficient quantities to extinguish fires in an occupied compartment, discharged through the orifices or diffuser 170 in the exterior of the unit 110. Such a system, mounted directly into the room to be protected, eliminates the expense of distribution plumbing from a remote storage site, and the expense of its installation. In a variation of this alternative embodiment, the unit 110 can be suspended to hang from the ceiling, or mount directly on the wall, including the use of a wall bracket similar to those used to position televisions in hospital rooms.

FIG. 5 is an illustration of single gas generator room unit, comprised of multiple gas generator cartridges. In this variation to the system disclosed in FIG. 4, the unit 210 houses multiple individual gas generator units 220, each sized of a particular capacity to provide a sufficient quantity of inert gas for a given volume of occupied space. An internal rack 230 is a means of selectively installing a variable number of units 220, each with their own squib 240 and wired to the detector 250, to provide a precise quantity of inert gas necessary to protect a given volume of an occupied space to be protected. Although the unit 210 can be sized sufficiently to add a large number of such units to protect a very large space, for very large compartments, multiple units 210 spaced throughout the compartment, may be warranted to provide better mixing and inert gas coverage in the room.

FIG. 6 is an illustration of a ceiling mounted fixture, holding multiple gas generator cartridges. A ceiling fixture 310 is mounted on the ceiling, extending a short distance below the ceiling height. Multiple gas generator units 320 can be mounted into the fixture at various bracket locations 330, much like the mounting brackets for individual fluorescent light bulbs. Like the system in FIG. 5, a varied number of units 320 can be added to the fixture 310 to vary the quantity of inert gas produced, and adjust for the room capacity to be protected. The fixture 310 can be sized to hold a certain maximum number of units 320, corresponding to a maximum room volume, or floor space for a given ceiling height, that can be protected with one fixture; beyond this room volume, additional fixtures would be added, spaced evenly throughout the room. As an additional option, the traditional room smoke detector 340 can be mounted into the fixture 310, such as in its center, to activate the units 320 directly within the fixture 310. In this manner, the electrical power wires applied to the detector can also be used to fire the squibs of the units, rather than a remote routing of the power and detector lines, and the expense of routing an additional power line above the ceiling. The fixture 310 is covered with decorative dust cover 350 that hides the units and fixture with an attractive cover that blends into the ceiling motif, and features exhaust holes 360 around its perimeter functioning as a diffuser to direct the inert gas 370 discharged by the units into the room. Such a location and manner of discharge of the system promotes effective mixing with the room air and gives maximum distance for the hot inert gas to cool before coming into contact with occupants below. The location on the ceiling permits the system to require no floor space or room location for mounting, thereby not impeding any activities or usage of the room's floor space.

FIG. 7 is an illustration of a ceiling mounted fixture, comprised of multiple recessed gas generator units. This unit is virtually identical to the system disclosed in FIG. 6, except this variant exploits the presence of a drop ceiling common to many business and computer rooms, or any other ceiling configuration that permits the mounting of the gas generator units 410 above the ceiling level. The units 410 are mounted to a ceiling cover 420 that are flush with the ceiling, with exhaust holes 430 present in the cover 420 to permit the diffusion and discharge of the inert gas 440 from the gas generator units 410. This configuration has the advantage of having a flush-mounted ceiling unit, without any extension below the ceiling, in an even more discreet design.

Such “in-room” gas generator fire protection systems, with their local detection, power (if supplied with back up power from capacitors or small batteries) and discharge capabilities all present within the compartment, provides a robust protection system that is not impeded by power loss or loss of water pressure, or physical destruction of buildings or structures, or water mains (which would also render water sprinklers unusable) in the event of a catastrophic event at the facility in question, due to earthquakes or other natural disasters, explosions such as due to leaking gas mains, or even terrorist incidents, to continue to provide protection to critical compartments even if the rest of the facility is severely compromised.

An illustration of a particular sizing example will demonstrate the features of the configurations set forth in the alternative embodiments of FIGS. 4-7.

An oxygen concentration of 12% is a desirable target level to provide for occupancy of a space up to 5 minutes during efficient suppression of a fire. Prior testing of prototype gas generator units has shown successful fire extinguishment with units sized approximately 20 gallons in volume, producing 0.53 5 kg-moles of nitrogen inert gas, discharged into a 1300 cubic foot room, an equivalent volume to be protected by one standard canister of traditional compressed stored inert gas. Such a unit was not optimized in size in any respect, with copious and un-optimized quantities of cooling bed materials used to cool the discharged nitrogen gas.

If such an un-optimized unit were prorated in size, including its oversized cooling bed capacity, it can provide a vastly conservative estimate of sizing on individual units and cartridges necessary when considering current art in gas generator technology and performance. The 0.535 kg-moles of gas can be increased to 0.6884 kg-moles to add the 20% factor of safety required, to result in an acceptable oxygen concentration for the normally occupied space. Sizing for protection for only 100 cubic feet of room space, a total of 1.483 kg of nitrogen is needed, rounded up to 1.5 kg. Using the effective density of the tested unit, even with the un-optimized cooling bed, disc-shaped units of 24 inch diameter, and 1.5 inches thick, or rectangular units 4 inches thick by 9 inches wide and 18 inches long, can produce such quantities. Either unit variant is calculated to weigh 23.4 lbs., if scaling the previously tested 240 lb. unit. Numerous disc shaped units can be stacked for the floor or wall-mounted model; to protect the 1300 cubic feet space associated with a standard compressed inert gas canister, a unit 24 inches in diameter and 19.5 inches tall would be necessary (taking very little space in the room). Such a unit could be increased in room capacity if needed by making it wider or taller (theoretically up to the ceiling height), but it may be alternatively preferred to add additional floor units in a large room. For the ceiling mounted units, the aforementioned rectangular gas generator units could be employed. This would result in an extended fixture distance below the ceiling of the unit of just over 4 inches. The units that recess into the ceiling could be of approximately 10 inches in diameter and 8 inches tall. These individual units can be seen to be of a weight practical for an individual installation technician to lift and install into the overhead ceiling fixture.

If such fixtures are designed to hold up to eight gas generator cartridges per fixture, to protect a ten by ten floor space if an eight foot ceiling is present, then even the total maximum fixture weight of 187 lbs. is practical for mounting to ceiling joists (and less than some ornate lighting fixtures). The individual gas generator units would be designed to discharge their gas along opposite sides along their length through multiple orifices, with such a configuration canceling any thrust loads otherwise possible. Such eight-unit fixtures would only take the ceiling space of about three foot by three foot, including space between the gas generator units for gas to discharge and flow, which is roughly equivalent in area to two common ceiling tiles. The oxygen concentration will only fluctuate in an 800 cubic foot space of less than 1% as one adjusts and adds each additional discrete gas generator unit to adjust for extra room capacity, which is certainly an acceptable tolerance level. In addition, one or two of the additional individual gas generator units can be used under the sub-floor of common computer rooms, to provide required fire protection in those spaces as well. Having a standard size for the cartridges works in favor of reducing the cost in gas generator production, by making many units of one size. If gas generator propellants and units continue to be optimized in the future, individual units as small as 4 inches by 2.5 inches by 5 inches, and a weight of 3.3 lbs. are possible, and full eight-unit ceiling fixtures could fit within a 12 inch square with a four inch thickness, and a weight of 26.5 lbs. fully loaded, if unit efficiencies near 100% are approached.

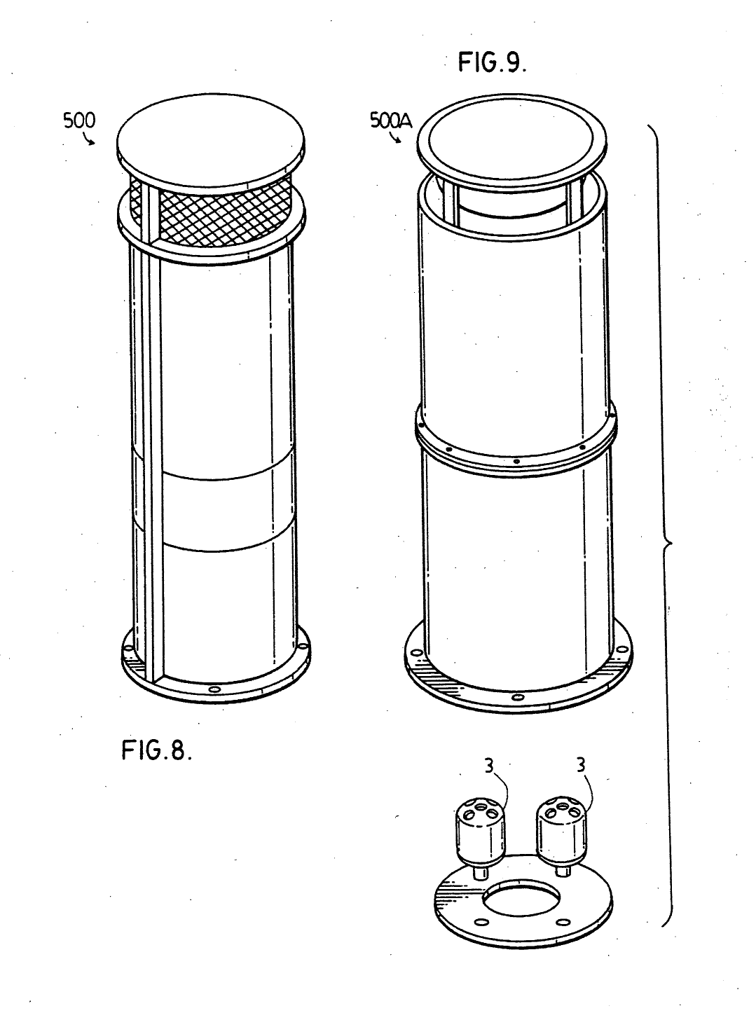

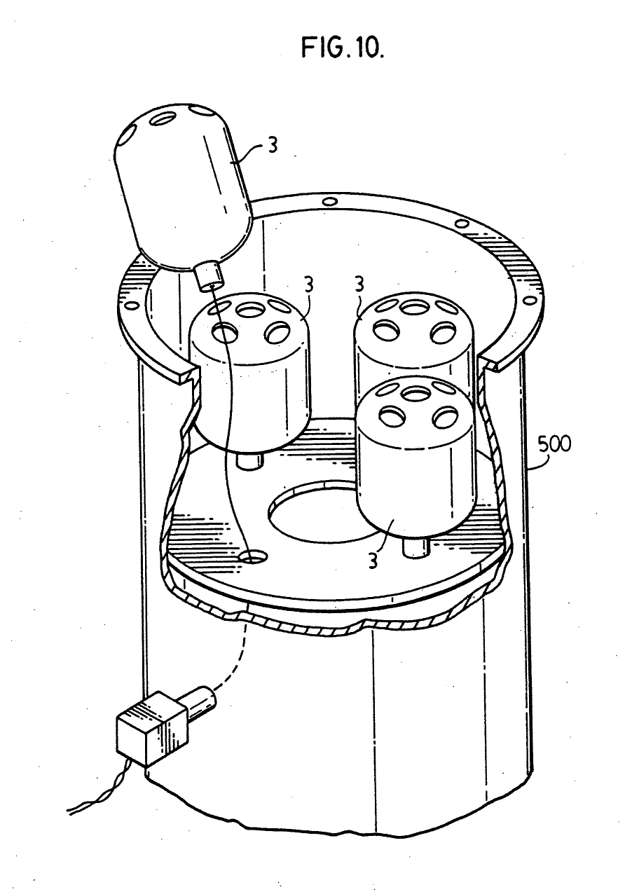

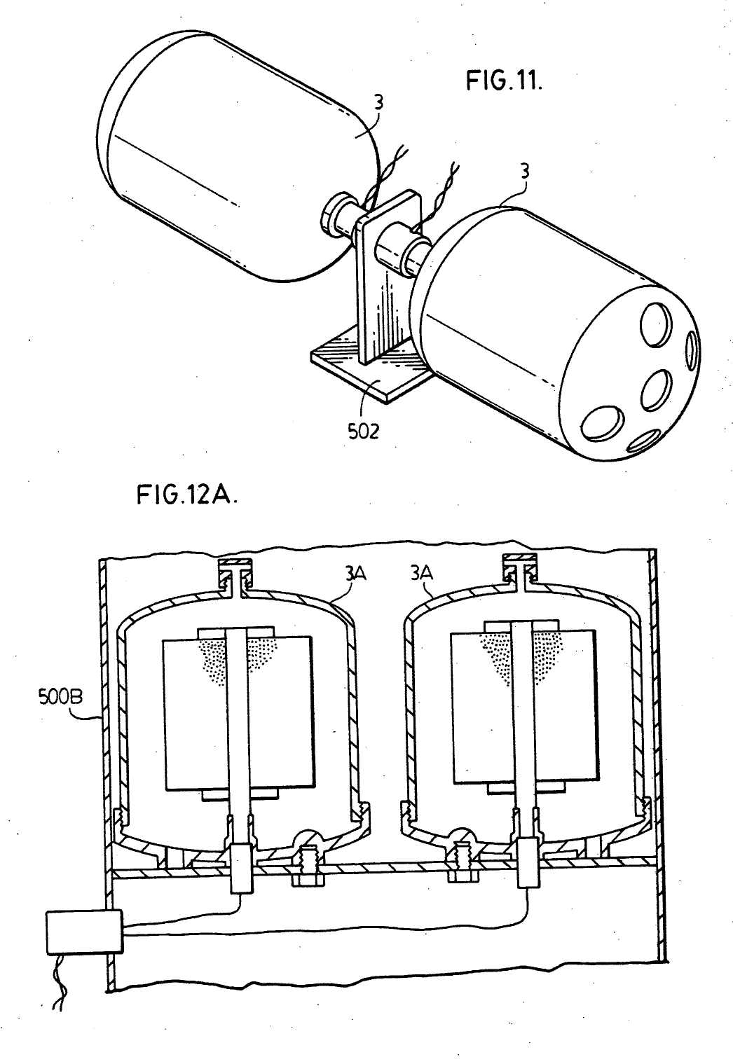

An illustration of a representative production tower design is shown in FIG. 8, and a photograph of a preliminary tower mockup with generators, is shown in FIG. 9. FIG. 10 is a photograph of a technician installing one of the cartridges in the interior of a tower, and connecting its power harness. FIG. 11 is a photograph of a special assembly designed to mount one or more generator cartridges underneath the sub-floor of a computer room. This configuration does not make use of a tower housing.

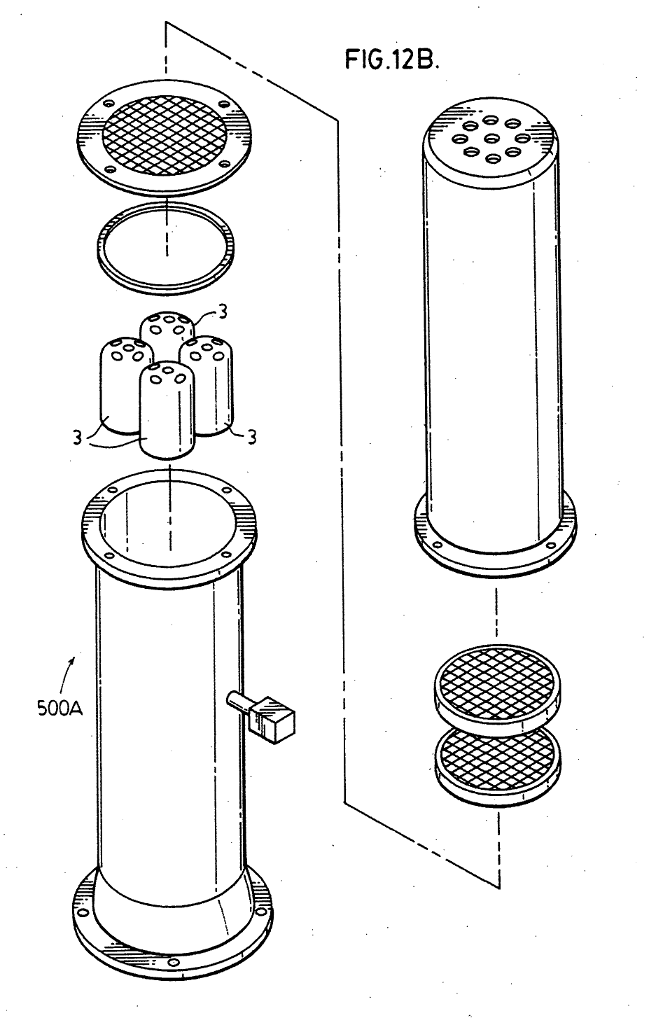

FIG. 12 shows a tower design housing four azide-based nitrogen generating generators.

There are thus described novel techniques and features to improve the performance of fire extinguishing systems for occupied spaces employing sodium based propellant gas generators, which meets all of the objectives set forth herein and which overcomes the disadvantages of existing techniques.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

Although embodiments have been described, those skilled in the art will appreciate that variations and modifications may be made without departing from the spirit and scope of the invention defined by the appended claims.

What is claimed is:

1. A device for delivering a fire suppressing gas to a space, comprising:
a housing disposed within the space;
at least one generator disposed within the housing and containing pre-packed sodium azide based propellant;
an ignition device for igniting said sodium azide based propellant and thereby generating a low-moisture fire suppressing gas; and
an opening in the housing for directing the fire suppressing gas mixture into said space.

2. The device of claim 1, further comprising at least one heat sink disposed between the at least one generator and the opening.

3. An apparatus for suppressing fires in a space comprising:
a. a sensor for detecting a fire;
b. at least one solid sodium azide based inert gas generator for generating and delivering a fire suppressing, substantially dry nitrogen gas mixture to the space upon receiving a signal from the sensor; and
c. an inert gas discharge diffuser to direct the fire suppressing gas mixture into said space.

4. A method of suppressing fires in a space comprising the steps of:
a. generating a first fire suppressing gas mixture from at least one sodium azide based propellant chemical, the first fire suppressing gas mixture comprising primarily nitrogen,
b. filtering at least one of moisture, additional gases and solid particulates from the first fire suppressing gas mixture to produce a second fire suppressing gas mixture; and
c. delivering the second fire suppressing gas mixture into the space.

5. The method of claim 4, comprising passing the second inert gas mixture through a heat sink material prior to discharging the generated gas mixture into the protected space.

5. The method as claimed in claim 6 wherein during the delivering the concentration of oxygen in the space permits occupants to remain in the space for up to five minutes.

6. The method as claimed in claim 4 further comprising the step of reducing the temperature of the second fire suppressing gas mixture by passing it through a heat sink material prior to delivering the second fire suppressing gas mixture into the space.

7. An apparatus for suppressing fires in a normally occupied and or un-occupied space comprising:
a. a sensor for detecting a fire;
b. at least one solid sodium azide based inert gas generator for generating and delivering a fire suppressing, substantially dry gas mixture including nitrogen to the space upon receiving a signal from the sensor; and
c. an inert gas discharge diffuser to direct the fire suppressing gas mixture into said space.

8. The apparatus as claimed in claim 7 wherein the fire suppressing gas mixture is predominantly nitrogen.

9. The apparatus as claimed in claim 7 wherein the fire suppressing gas mixture comprises at least two gases and the apparatus further comprises at least one filter for filtering at least a portion of at least one of the gases and or byproduct particulate from the fire suppression gas mixture, prior to the delivery thereof into an occupied and or un-occupied space.

10. The apparatus as claimed in claim 9 wherein the filter is adapted to filter substantially all of at least one of the gases and or particulate from the first suppressing gas mixture.

11. A gas generator for generating and delivering a substantially dry fire suppressing gas mixture to a space, comprising:
a. a housing;
b. at least one pre-packed sodium azide based propellant disposed within said housing;
c. a pyrotechnic device for igniting said sodium azide based propellant and thereby generating said fire suppressing gas mixture; and
d. a discharge diffuser for directing the fire suppressing gas mixture within said enclosed space.

12. The gas generator as claimed in claim 11, further comprising at least one filter for filtering at least a portion of one gas and or particulate from said fire suppressing gas mixture.

13. The gas generator as claimed in claim 11, further comprising at least one heat sink screen for reducing the temperature of said fire suppressing gas mixture.

14. The gas generator as claimed in claim 11, wherein said discharge diffuser includes a 180° directional cap.

15. The gas generator as claimed in claim 11, wherein said discharge diffuser includes a 360° directional cap.

16. The gas generator as claimed in claim 11, wherein said discharge diffuser includes a perforated cap.

17. The gas generator as claimed in claim 11, wherein said discharge diffuser includes a 90° directional cap.

18. The gas generator as claimed in claim 11, wherein said gas mixture is substantially nitrogen.
